(19) United States
(12) Patent Application Publication
(10) Pub. No.: US 2025/0296755 A1
(43) Pub. Date: Sep. 25, 2025

(54) ELECTRONIC COMPONENT COLLECTION, COLLECTION METHOD OF ELECTRONIC COMPONENTS AND MANUFACTURING METHOD OF ELECTRONIC DEVICE

(71) Applicant: INNOLUX CORPORATION, Miao-Li County (TW)

(72) Inventors: Ke-Biao SHI, Miao-Li County (TW); Xin-Qi DENG, Miao-Li County (TW); Wen-Hung LEE, Miao-Li County (TW)

(21) Appl. No.: 19/073,583

(22) Filed: Mar. 7, 2025

(30) Foreign Application Priority Data
Mar. 22, 2024 (CN) 202410334018.9

(51) Int. Cl. B65D 81/107; B65B 55/00; B65D 85/68

(52) U.S. Cl. CPC B65D 81/107; B65B 55/00; B65D 85/68; B65D 2585/86

(57) ABSTRACT

An electronic component collection, a collection method of electronic components and a manufacturing method of an electronic device. The electronic component collection includes a plurality of electronic components and at least one spacer. The spacer is disposed between two adjacent electronic components. The spacer includes a main body and at least one cut line. The main body has a first surface and a second surface opposite to each other. The first surface is adjacent to one of the two adjacent electronic components, and the second surface is adjacent to the other one of the two adjacent electronic components. The cut line is formed on the main body and extends in a first direction parallel to the first surface, and the cut line extends from the first surface to the second surface in a second direction to penetrate the main body.

### CROSS REFERENCE TO RELATED APPLICATIONS

This Non-provisional application claims priority under 35 U.S.C. § 119(a) on Patent Application No(s). 202410334018.9 filed in China on Mar. 22, 2024, the entire contents of which are hereby incorporated by reference.

### BACKGROUND

### Technology Field

The present disclosure relates to electronic components of an electronic device and, in particular, to an electronic component collection, a collection method of electronic components, and a manufacturing method of an electronic device.

### Description of Related Art

With the development of digital technology, electronic devices with display panels have been widely used in all aspects of daily life, such as televisions, computers, mobile phones and other modern information products. Among common display panels, the LCD (liquid crystal display) panel is one of the current mainstream products.

However, in the manufacturing process of display panels, when individual semi-finished panels are taken out of the container for processing, the spacer is often stuck on the semi-finished panel and cannot be removed smoothly, which hinders the subsequent automatic pickup process (automatic operation) and further processing, causing trouble to electronic device manufacturers.

Therefore, it is desired to provide an electronic component collection, a collection method of electronic components, and a manufacturing method of an electronic device that can prevent the glass fogging effect on the panels and/or does not affect the automatic operation of the manufacturing process of display panels.

### SUMMARY

The present disclosure provides an electronic component collection, a collection method of electronic components, and a manufacturing method of an electronic device that can prevent the glass fogging effect on the electronic components and/or does not affect the automatic operation of the manufacturing process of electronic devices.

An electronic component collection of this disclosure includes a plurality of electronic components and at least one spacer. The spacer is disposed between adjacent two of the electronic components, and the spacer includes a main body and at least one cut line. The main body has a first surface and a second surface opposite to the first surface. The first surface is adjacent to one of the adjacent two electronic components, and the second surface is adjacent to the other one of the adjacent two electronic components. The cut line is formed on the main body and extends in a first direction parallel to the first surface, and the cut line extends from the first surface to the second surface in a second direction so as to penetrate the main body.

A collection method of electronic components of this disclosure includes the following steps of: picking a first electronic component; picking a spacer and placing the spacer on the first electronic component; and picking a second electronic component and placing the second electronic component on the spacer. The spacer includes a main body and at least one cut line. The main body has a first surface and a second surface opposite to the first surface. The first surface is adjacent to the first electronic component, and the second surface is adjacent to the second electronic component. The cut line is formed on the main body and extends in a first direction parallel to the first surface, and the cut line extends from the first surface to the second surface in a second direction so as to penetrate the main body.

A manufacturing method of an electronic device of this disclosure, which is applied with the above-mentioned electronic component collection, includes the following steps of: retrieving the spacer from the electronic component collection; retrieving one of the electronic components from the electronic component collection; and forming the electronic device with the retrieved electronic component.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a schematic diagram showing an electronic component collection according to an embodiment of this disclosure, wherein the electronic component collection is not put in a container yet;

FIG. 2 is a top view of the spacer according to an embodiment of this disclosure;

FIG. 3 is a top view of another aspect of the space according to the embodiment of this disclosure;

FIGS. 4 to 8 are top views of the spacers according to different embodiments of this disclosure;

FIG. 9 is a flow chart of a collection method of electronic components according to an embodiment of this disclosure; and

FIG. 10 is a flow chart of a manufacturing method of an electronic device according to an embodiment of this disclosure.

### DETAILED DESCRIPTION OF THE DISCLOSURE

The present disclosure will be apparent from the following detailed description, which proceeds with reference to the accompanying drawings, wherein the same references relate to the same elements.

It should be understood that the following description provides different embodiments for implementing different aspects of some embodiments of the present disclosure. The specific components and arrangements described below are used to briefly and clearly describe some embodiments of the present disclosure. These embodiments are for illustration and are not intended to limit the scope of the present disclosure. In addition, reference numbers or labels may be repeatedly used in different embodiments. These repetitions are only for the purpose of simply and clearly describing some embodiments of the present disclosure, and do not represent any correlation between the different embodiments and/or structures discussed. Furthermore, when it is mentioned that a certain element is on or above another element, the certain element may directly contact another element, or one or more other elements may be provided between the two elements, so that the certain element may not directly contact another element.

Relative terms, such as “lower” and “higher”, or “bottom” and “top”, may be used in following embodiments to describe the relative relationship of one component to another component in the drawings. It will be understood that if the device shown in the drawings is turned upside down, components described as being at the “lower” side would then be at the “higher” side.

The terms “about”, “approximate” and “approximately” usually mean the variation within 20%, preferably within 10%, and more preferably within 5%, 3%, 2%, 1% or 0.5% of a given value or range. The given quantities here are approximate quantities, that is, in the absence of specific description of “about”, “approximate”, or “approximately”, the meaning of “about”, “approximate”, and “approximately” can still be implied.

It will be understood that, although the terms “first”, “second”, “third” and the likes may be used herein to describe various elements, components, regions, layers, and/or portions, these elements, components, regions, layers, and/or portions should not be limited by these terms, and these terms are used to distinguish between different elements, components, regions, layers, and/or portions. Thus, a first element, component, region, layer, and/or portion discussed below could be termed a second element, component, region, layer, and/or portion without departing from the teachings of some embodiments of the present disclosure.

Unless otherwise defined, all terms (including technical and scientific terms) used herein have the same meaning as commonly understood by one of ordinary skill in the related art. It is understood that these terms, such as those defined in commonly used dictionaries, should be interpreted to have a meaning consistent with the relevant technology and the background or content of the present disclosure, and should not be interpreted in an idealized or overly formal way, unless otherwise defined in the embodiments of this disclosure.

Some embodiments of the present disclosure can be understood together with the drawings, and the drawings of the embodiments of the present disclosure are also regarded as part of the description of the embodiments of the present disclosure. It should be understood that the drawings of the embodiments of the present disclosure are not drawn to the actual scale of devices and components. The shapes and thicknesses of embodiments may be exaggerated in the drawings to clearly illustrate features of embodiments of the present disclosure. In addition, the structures and devices in the drawings are illustrated in a schematic manner in order to clearly demonstrate the features of the embodiments of the present disclosure.

In some embodiments of the present disclosure, relative terms such as “lower”, “upper”, “parallel”, “vertical”, “below”, “above”, “top”, “bottom”, etc., shall be understood as the orientations shown in this paragraph and related drawings. This relative terms are for convenience of explanation and does not mean that the device described needs to be manufactured or operated in a specific orientation. Terms related to joining and connecting, such as “connect”, “joint”, etc., unless otherwise defined, can mean that two structures are in direct contact, or they can also mean that the two structures are not in direct contact with one or more additional structures located therebetween. The terms related to joining and connecting two structures can also include the situation that both structures are movable, or both structures are fixed.

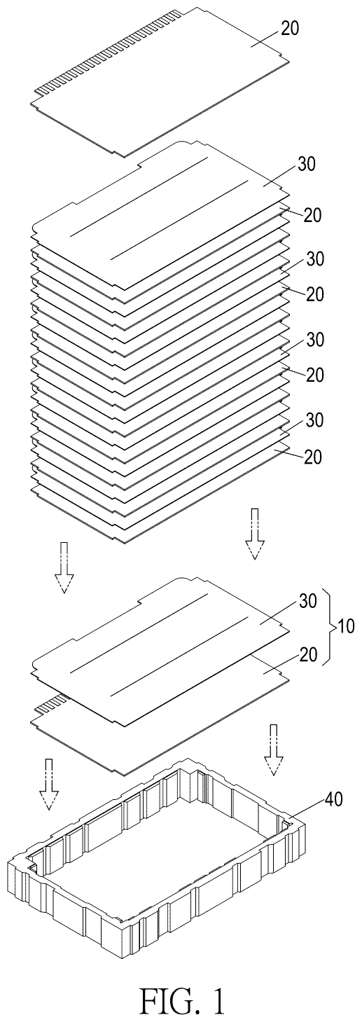

FIG. 1 is a schematic diagram showing an electronic component collection 10 according to an embodiment of this disclosure, wherein the electronic component collection 10 is not put in a container 40 yet. In this disclosure, the electronic component collection 10 includes a plurality of electronic components 20 and at least one spacer 30. Each spacer 30 is disposed between adjacent two of the electronic components 20.

As shown in FIG. 1, the electronic component collection 10 of this embodiment includes, for example, twelve electronic components 20 and eleven spacers 30. The electronic components 20 and the spacers 30 are stacked in a staggered manner. Specifically, one space 30 is disposed between adjacent two of the electronic components 20, and one electronic component 20 is disposed between adjacent two of the spacers 30. To be noted, the amounts of these elements are for illustrations, and this disclosure is not limited thereto.

Furthermore, the electronic components 20 and the spacers 30 are closely stacked and accommodated in a corresponding container 40. The internal space of the container 40 can match the outer contours of the electronic components 20 and the spacers 30, so that the stacked electronic components 20 and spacers 30 can be accommodated in the container 40. In addition, after accommodating the electronic components 20 and the spacers 30 in the container 40, a cover (not shown) can be provided on the upper side of the container 40. For example, the cover can be made of the same material as the container 40, or a buffer material for providing a proper protection, and this disclosure is not limited thereto. The spacers 30 may be made of a material with buffering function and/or partitioning function, such as plastic, polymer material, metal material, ceramic material, or the likes. In this embodiment, the material of the spacers 30 includes, for example, expanded polyethylene foam, ethylene vinyl acetate copolymer, or the likes, and this disclosure is not limited thereto.

In this embodiment, each electronic component 20 may be, for example but not limited to, a semi-finished panel. In particular, each electronic component 20 may be, for example but not limited to, a semi-finished liquid crystal panel, a semi-finished OLED (organic light-emitting diode) panel, a semi-finished EL (electroluminescent) panel, a semiconductor component, or the likes, but the present disclosure is not limited thereto. In this embodiment, each electronic component 20 is a semi-finished liquid crystal panel as an example.

For example, the electronic component 20 may include, for example, a first substrate, a second substrate and a display medium layer (not shown). The first substrate and the second substrate are opposite to each other, and the display medium layer is sandwiched between the first substrate and the second substrate. The display medium layer can be a liquid crystal layer, so that the electronic component 20 can be made as a semi-finished liquid crystal panel. The first substrate or the second substrate can be made of a light-transmitting material, such as glass, quartz or the like, plastic, rubber, glass fiber or any of other polymer materials. In other embodiments, the first substrate or the second substrate can be made of opaque material, such as metal-glass fiber composite board, metal-ceramic composite board, printed circuit board, or any of other materials.

In addition, the electronic component 20 can further include a light-shielding layer, a color filter layer and a protective layer (not shown). The light-shielding layer and the color filter layer are arranged on the first substrate. In one embodiment, the light-shielding layer and the color filter layer are included in a color filter array and are disposed on the first substrate, so that the first substrate including the color filter array can function as a color filter substrate. In addition, a TFT (thin-film transistor) array can be disposed on the second substrate, so that the second substrate including the TFT array can function as a TFT substrate. However, in other embodiments, the light-shielding layer or the color filter layer can also be disposed on the second substrate so as to form a BOA (BM on array) substrate or a COA (color filter on array) substrate. To be noted, this disclosure is not limited thereto. In one embodiment, the light-shielding layer has a plurality of openings, and these openings are light transmittable areas. The light-shielding layer can be, for example, a black matrix, and may be made of an opaque material, such as metal or resin. For example, the metal may be chromium, chromium oxide, or a chromium oxynitride compound. Since the light-shielding layer is made of an opaque material, the first substrate can be provided with opaque areas, thereby defining light-transmitting areas. In addition, the color filter layer of this embodiment may include, for example but not limited to, blocks of three colors in a repeated arrangement, such as, for example but not limited to, red (R), green (G), and blue (B). The material of these blocks may be light transmittable material, such as a pigment or a dye.

In one embodiment, the protective layer (e.g. an over-coating) can cover the light-shielding layer and the color filtering layer. The material of the protective layer can include photoresist material, resin material or inorganic material (e.g. SiOx/SiNx), etc., to protect the light-shielding layer and the color filter layer from being damaged by subsequent processes. In addition, the display panel may further include a sealant (not shown). The sealant is disposed between the first substrate and the second substrate and seals the periphery between the first substrate and the second substrate. The sealant may be a light-curing adhesive (e.g. UV glue), and can, for example but not limited to, be disposed around the periphery of the first substrate and the second substrate in the atmosphere. In addition, the sealant, the first substrate and the second substrate may form an accommodation space (not shown) therebetween, and the display medium layer is disposed in the accommodation space. In this case, the display medium layer can be formed by filling liquid crystal molecules into the accommodation space surrounded by the sealant using, for example but not limited to, ODF (one drop filling).

In one embodiment, the electronic component 20 may further include one or more optical films or layers, such as, for example but not limited to, polarizing layer (e.g. upper polarizer or lower polarizer), polarizing sheet, anti-reflection film, explosion-proof film, etc. These films or layers are well known to those skilled in the art, so the detailed descriptions thereof will be omitted.

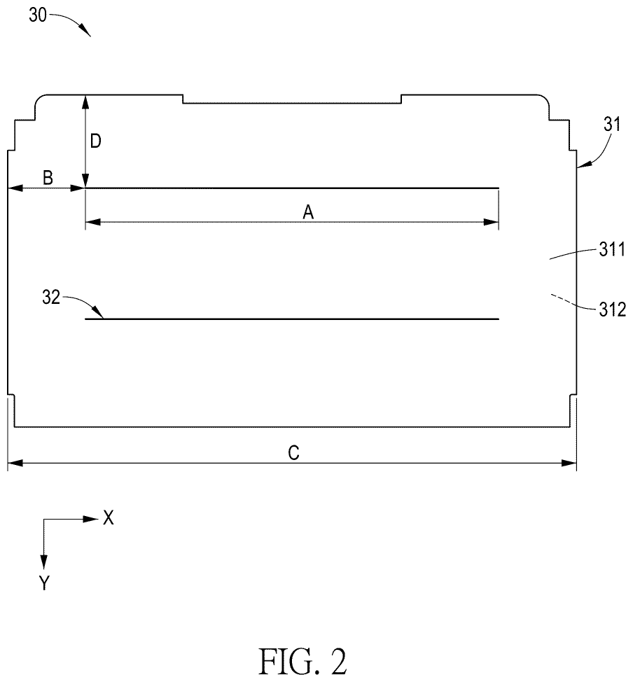

With reference to FIG. 2, each spacer 30 includes a main body 31 and at least one cut line 32. The main body 31 has a first surface 311 and a second surface 312 disposed opposite to the first surface 311. The first surface 311 is adjacent to one of two adjacent electronic components 20, and the second surface 312 is adjacent to the other one of the two adjacent electronic components 20. Specifically, please refer to FIG. 1 and FIG. 2, the first surface 311 can be, for example, the upper surface of the main body 31, and the second surface 312 can be, for example, the lower surface of the main body 31. The first surface 311 is located adjacent to one electronic component 20, which is arranged at the upper side of the spacer 30, and the second surface 312 is located adjacent to another electronic component 20, which is arranged at the lower side of the spacer 30. In addition, in this embodiment, the size and contour shape of the main body 31 of each spacer 30 can roughly match the electronic component 20. For example, the size and contour shape of the main body 31 of each spacer 30 can match the size and contour shape of the display surface (e.g. a glass substrate, a polarizer, etc.) of each electronic component 20. This design of the spacers 20 can provide appropriate protection to the electronic components 20. In addition, the material of the main body 31 of this embodiment may be, for example but not limited to, a foaming material, but this disclosure is not limited thereto.

Referring to FIG. 2, the spacer 30 of this embodiment may include, for example but not be limited to, two cut lines 32 formed on the main body 31 and extending in a first direction X parallel to the first surface 311, and each cut line 32 extends from the first surface 311 to the second surface 312 in a second direction to penetrate the main body 31. In this embodiment, the first surface 311 and the second surface 312 of the spacer 30 approximately have a rectangular shape. The first direction X can be, for example, a direction parallel to the long axis of the rectangle, and the second direction is, for example, a direction perpendicular to the first surface 311 (or the second surface 312). In other words, the second direction can also be understood as the normal direction of the first surface 311 or the second surface 312. In another embodiment, for example, the second direction and the first surface can have an included angle therebetween, but the present disclosure is not limited thereto.

In this embodiment, each cut line 32 has a width in a third direction Y, which is perpendicular to the first direction X and the second direction, and the width is between 0.1 mm and 1 mm (0.1 mm≤the width of the cut line 32≤1 mm). It should be noted that the above width range is only for an example, and this disclosure is not limited thereto.

In this embodiment, the main body 31 is defined with a length C in the first direction X, and each cut line 32 is defined with a length A in the first direction X. The length A is 40˜80% of the length C (40%*C≤A≤80%*C). In addition, in this embodiment, a first distance B is defined between the cut line 32 and the edge of the main body 31 in the first direction X, and the first distance B is 10˜30% of the length C (10%*C≤B≤30%*C). In this embodiment, a second distance D is defined between the cut line 32 and the other edge of the main body 31 in the third direction Y, and the second distance D is 10˜30% of the length C of the main body 31 (10%*C≤D≤30%*C). Based on the above-mentioned ranges of the first distance B and the second distance D, each cut line 32 can have a sufficient length to provide a vacuum-breaking effect between two adjacent ones of the stacked electronic components of the electronic component collection, thereby avoiding the situation that the spacer 30 is stuck to the electronic component 20 (e.g. a semi-finished panel) and cannot be removed smoothly. In addition, the spacer 30 with the above-mentioned cut lines 32 can have an ensured structural strength to avoid the cracking along the cut lines 32. To be noted, the above ranges of the first distance B and the second distance D are only examples, and the present disclosure is not limited thereto.

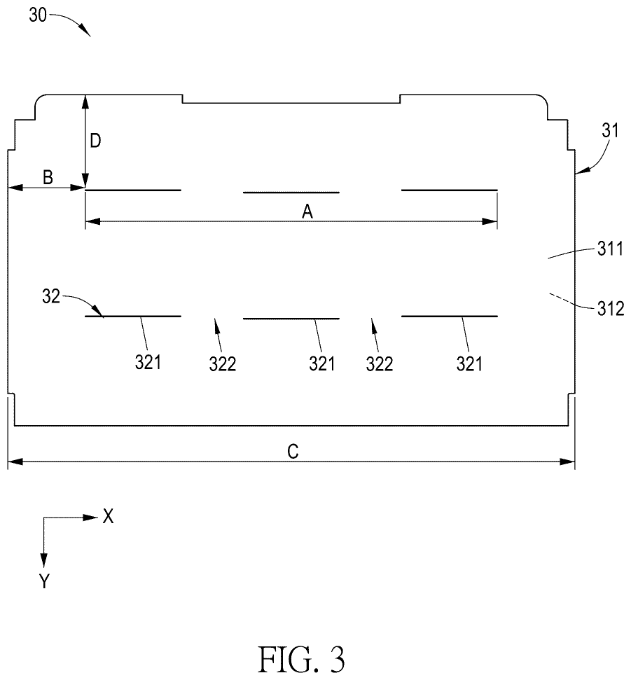

In another aspect of this embodiment as shown in FIG. 3, the spacer 30 may include, for example but not be limited to, two cut lines 32, which are formed on the main body 31 and extending in the first direction X parallel to the first surface 311. Each cut line 32 extends from a first surface 311 to a second surface 312 to penetrate the main body 31, and each cut line 32 includes at least two cut line segments 321 and at least one interval 322 disposed between the at least two cut line segments 321. In this embodiment, each cut line 32 includes three cut line segments 321 and two intervals 322 disposed between the cut line segments 321. In addition, in this embodiment, in the same cut line 32, the ratio of the total length of all cut line segments 321 to the total length of all intervals 322 can be, for example but not limited to, 1˜2, but this disclosure is not limited thereto. In another embodiment, the ratio of the total length of all cut line segments 321 to the total length of all intervals 322 can be 1.5˜2.

To be noted, the number of the cut lines and the design of the cut line segments and intervals disclosed in the above embodiment are only exemplary and are not intended to limit the scope of this disclosure. The number of the cut lines and the design of the cut line segments and intervals can be adjusted according to actual needs. Several applicable designs will be disclosed below with reference to the drawings.

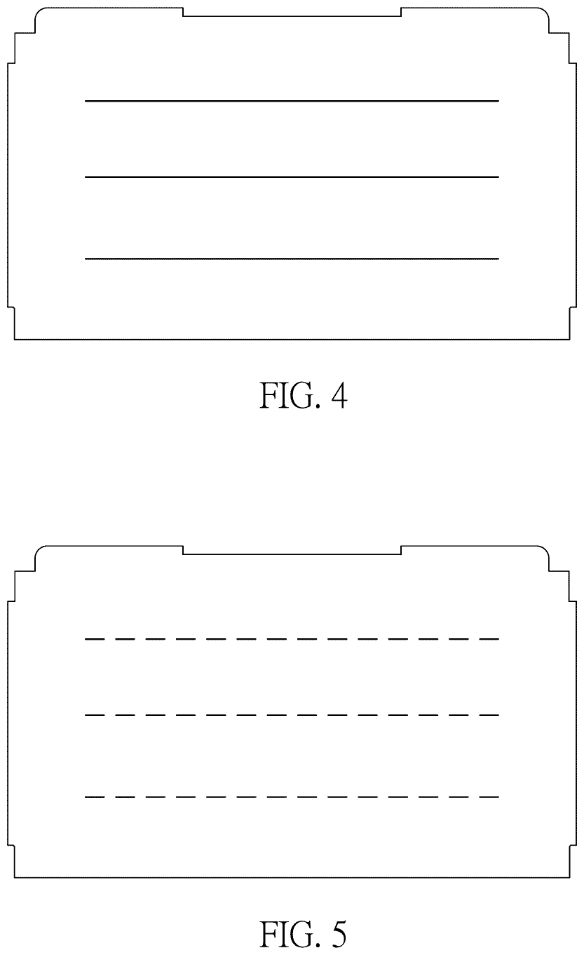

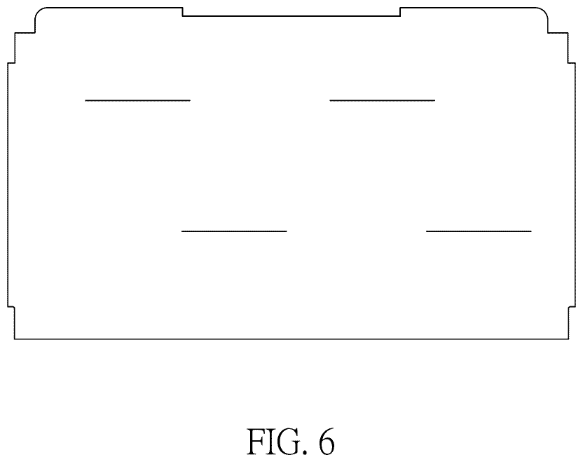

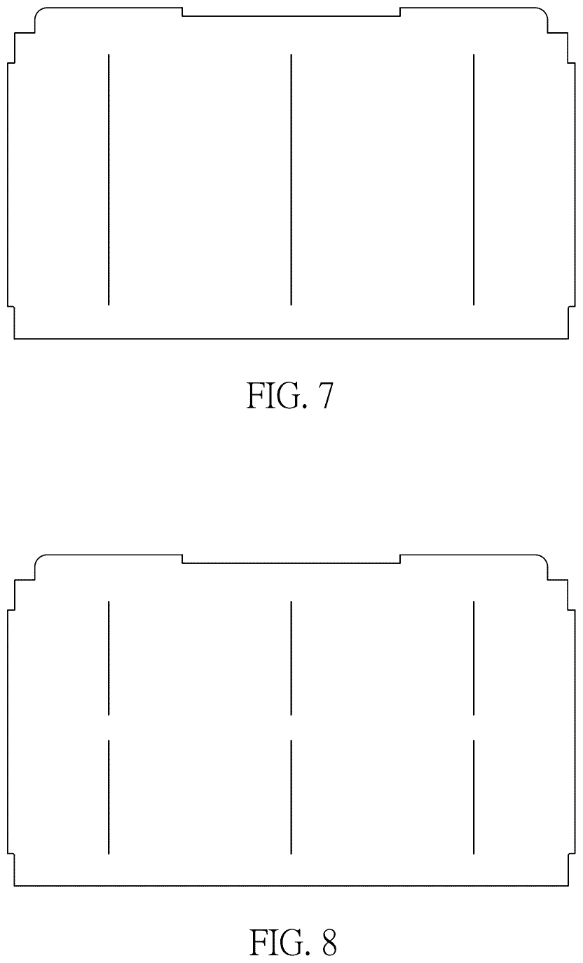

In one embodiment, the spacer 30 may include more than two cut lines 32. For example, the spacer 30 may include three cut lines 32 (see FIG. 4). In another embodiment, the spacer 30 may include three cut lines 32, and each cut line 32 may include more cut line segments 321 and a plurality of intervals 322 disposed between the cut line segments 321 (see FIG. 5). In another embodiment, the spacer 30 includes two cut lines 32, and each cut line 32 includes a plurality of cut line segments 321 and at least one interval 322 disposed between any two of the cut line segments 321. In this case, the designs and/or numbers of the cut line segments 321 and the intervals 322 in different cut lines 32 are different (see FIG. 6). In another embodiment, the spacer 30 may include three cut lines 32, and each cut line 32 is formed on the main body 31 and extends in the third direction Y (see FIG. 7). In another embodiment, the spacer 30 may include three cut lines 32, and each cut line 32 is formed on the main body 31 and extends in the third direction Y. Each cut line 32 includes a plurality of cut line segments 321 and at least one interval 322 disposed between the cut line segments 321 (see FIG. 8).

In the above-mentioned embodiments, each cut line 32 has a generally linear design and is arranged parallel to the long axis (the first direction X) or the short axis (the third direction Y) of the main body 31, but this disclosure is not limited thereto. In other embodiments, each cut line may be arranged non-parallel to the long axis (the first direction X) or the short axis (the third direction Y) of the main body 31. In other embodiments, each cut line may be a combination of multiple cut line segments. For example, each cut line can be composed of two cut line segments connected to form an inverted V-shaped cut line. In another embodiment, each cut line may be composed of two crossed line segments to form a “+” shape. In another embodiment, each cut line may be composed of a plurality of nonlinear line segments. For example, each cut line may be composed of two curved line segments to form an inverted U-shaped cut line. It should be noted that the features of the above embodiments can be mixed and matched arbitrarily as long as they do not violate or conflict the spirit of this disclosure, and this disclosure is not limited thereto. In summary, the electronic component collection of the present disclosure includes a plurality of electronic components and at least one spacer, and the spacer is disposed between two adjacent electronic components. The spacer includes a main body and at least one cut line. The main body has a first surface and a second surface disposed opposite to the first surface. The first surface is adjacent to one of the two adjacent electronic components, and the second surface is adjacent to the other one of the two adjacent electronic components. The cut line is formed on the main body and extends in a first direction parallel to the first surface, and the cut line extends from the first surface to the second surface in a second direction perpendicular to the first surface to penetrate the main body. Since the spacer is formed with the cut line(s), when the electronic component collection of the present disclosure is supplied to the downstream manufacturers for subsequent manufacturing of electronic devices, the phenomenon of glass fogging on the electronic components can be avoided without affecting the automatic operation of the manufacturing process of electronic devices.

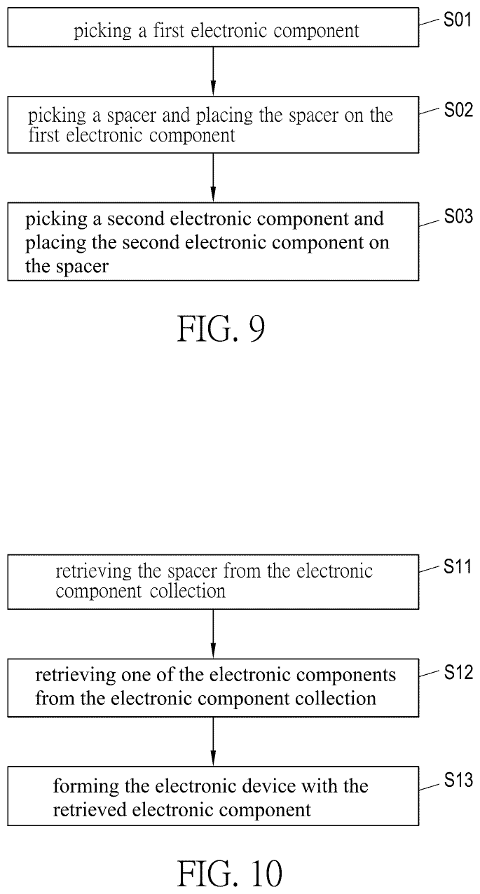

FIG. 9 is a flow chart of a collection method of electronic components according to an embodiment of this disclosure.

Referring to FIG. 9, the collection method of electronic components of this disclosure includes the following steps of: picking a first electronic component (step S01), wherein the picked first electronic component can be, for example but not limited to, the above-mentioned electronic component 20; picking a spacer and placing the spacer on the first electronic component (step S02), wherein the picked spacer can be, for example but not limited to, the above-mentioned spacer 30; and picking a second electronic component and placing the second electronic component on the spacer (step S03), wherein the picked first electronic component can be, for example but not limited to, the above-mentioned electronic component 20. In this embodiment, the spacer includes a main body and at least one cut line. The main body has a first surface and a second surface opposite to the first surface. The first surface is adjacent to the first electronic component, and the second surface is adjacent to the second electronic component. The cut line is formed on the main body and extends in a first direction parallel to the first surface, and the cut line extends from the first surface to the second surface in a second direction so as to penetrate the main body. To be noted, the electronic component and spacer of this embodiment can be referred to the electronic component 20 and the spacer 30 of the previous embodiment, so the detail descriptions thereof will be omitted.

In addition, the collection method of electronic components of this disclosure may further include the step of: repeating the above steps S02 and S03 so as to obtain an electronic component collection 10. In this embodiment, the electronic component collection 10 includes a plurality of electronic components 20 and a plurality of spacers 30, and any adjacent two of the electronic components 20 is configured with one spacer 30 therebetween.

Moreover, the collection method of electronic components of this disclosure may further include the step of: performing a packing step to packing the electronic component collection in a container. To be noted, in practice, a plurality of electronic components 20 and a plurality of pads 30 can be alternately stacked to form an electronic component collection 10, and then the entire electronic component collection 10 can be moved loaded into a container to perform this packing step. In another case, a plurality of electronic components and a plurality of spacers are alternately placed and stacked in the container. When the container is filled with the electronic components and spacers, this packing step can be completed. In addition, this packing step may further include adding a cover on the container. It should be noted that the above packing step is only an example, and this disclosure is not limited thereto.

As mentioned above, the collection method of electronic components of this disclosure includes the following steps of: picking a first electronic component; picking a spacer and placing the spacer on the first electronic component; and picking a second electronic component and placing the second electronic component on the spacer. The spacer includes a main body and at least one cut line. The main body has a first surface and a second surface opposite to the first surface. The first surface is adjacent to the first electronic component, and the second surface is adjacent to the second electronic component. The cut line is formed on the main body and extends in a first direction parallel to the first surface, and the cut line extends from the first surface to the second surface in a second direction so as to penetrate the main body. Since the spacer is formed with the cut line(s), when the collection method of electronic components of this disclosure is performed to prepare the electronic component collection, and then the electronic component collection is supplied to the downstream manufacturers for subsequent manufacturing of electronic devices, the phenomenon of glass fogging on the electronic components can be avoided without affecting the automatic operation of the manufacturing process of electronic devices.

FIG. 10 is a flow chart of a manufacturing method of an electronic device according to an embodiment of this disclosure.

Referring to FIG. 10, the manufacturing method of an electronic device of this embodiment includes the following steps of: retrieving the spacer from the electronic component collection (step S11), wherein the electronic component collection can be, for example but not limited to, the above-mentioned electronic component collection 10, and the spacer can be, for example but not limited to, the above-mentioned spacer 30; retrieving one of the electronic components from the electronic component collection (step S12), wherein the electronic components can be, for example but not limited to, the above-mentioned electronic components 20; and forming the electronic device with the retrieved electronic component (step S13).

In this embodiment, the spacer includes a main body and at least one cut line. The main body has a first surface and a second surface opposite to the first surface. The first surface is adjacent to one of the adjacent two electronic components, and the second surface is adjacent to the other one of the adjacent two electronic components. The cut line is formed on the main body and extends in a first direction parallel to the first surface, and the cut line extends from the first surface to the second surface in a second direction so as to penetrate the main body. In this embodiment, since the spacer is formed with at least one cut line, the step S11 can be performed smoothly to remove the spacer and the spacer is not stuck to the electronic component. To be noted, the electronic component collection, the electronic components and the spacers can be referred to the electronic component collection 10, the electronic components 20, and the spacers 30 of the previous embodiment, so the detailed descriptions thereof will be omitted.

Moreover, in the manufacturing method of an electronic device of this disclosure, the electronic device formed by the step S13 can be, for example but not limited to, an LCD device, and the electronic component can be, for example but not limited to, a semi-finished liquid crystal panel. In this case, the step S13 is to assemble the semi-finished liquid crystal panel (electronic component) and a backlight module in a case or frame so as to form an LCD device (electronic device). To be noted, the above description are for an example, and this disclosure is not limited thereto.

As mentioned above, the manufacturing method of an electronic device of this disclosure includes the following steps of: retrieving the spacer from the electronic component collection; retrieving one of the electronic components from the electronic component collection; and forming the electronic device with the retrieved electronic component. The spacer includes a main body and at least one cut line. The main body has a first surface and a second surface opposite to the first surface. The first surface is adjacent to one of the adjacent two electronic components, and the second surface is adjacent to the other one of the adjacent two electronic components. The cut line is formed on the main body and extends in a first direction parallel to the first surface, and the cut line extends from the first surface to the second surface in a second direction so as to penetrate the main body. Since the spacer is formed with the cut line(s), when performing the manufacturing method of an electronic device of the present disclosure, the phenomenon of glass fogging on the electronic components can be avoided without affecting the automatic operation of the manufacturing process of electronic devices.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. An electronic component collection, comprising:
a plurality of electronic components; and
at least one spacer, wherein the spacer is disposed between adjacent two of the electronic components, and the at least one spacer comprises:
a main body having a first surface and a second surface opposite to the first surface, wherein the first surface is adjacent to one of the adjacent two of the electronic components, and the second surface is adjacent to the other one of the adjacent two of the electronic components, and
at least one cut line formed on the main body and extending in a first direction parallel to the first surface, wherein the at least one cut line extends from the first surface to the second surface in a second direction so as to penetrate the main body.

2. The electronic component collection of claim 1, wherein a width of the at least one cut line in a third direction is between 0.1 mm and 1 mm, and the third direction is perpendicular to the first direction and the second direction.

3. The electronic component collection of claim 1, wherein a length of the at least one cut line in the first direction is between 40% and 80% of a length of the main body in the first direction.

4. The electronic component collection of claim 1, wherein a first distance is defined between the at least one cut line and an edge of the main body in the first direction, and the first distance is between 10% and 30% of a length of the main body in the first direction.

5. The electronic component collection of claim 2, wherein a second distance is defined between the at least one cut line and an edge of the main body in the third direction, and the second distance is between 10% and 30% of a length of the main body in the third direction.

6. The electronic component collection of claim 1, wherein the at least one cut line comprises at least two cut line segments and at least one interval between the at least two cut line segments.

7. The electronic component collection of claim 6, wherein a ratio of a total length of the at least two cut line segments to a total length of the interval is between 1 and 2.

8. The electronic component collection of claim 1, wherein a material of the main body comprises a foaming material.

9. A collection method of electronic components, comprising:
picking a first electronic component;
picking a spacer and placing the spacer on the first electronic component; and
picking a second electronic component and placing the second electronic component on the spacer;
wherein, the spacer comprises:
a main body having a first surface and a second surface opposite to the first surface, wherein the first surface is adjacent to the first electronic component, and the second surface is adjacent to the second electronic component, and
at least one cut line formed on the main body and extending in a first direction parallel to the first surface, wherein the at least one cut line extends from the first surface to the second surface in a second direction so as to penetrate the main body.

10. The collection method of claim 9, wherein the first electronic component, the spacer and the second electronic component are collected to form an electronic component collection, and the collection method further comprises:
performing a packing step to packing the electronic component collection in a container.

11. The collection method of claim 9, wherein a width of the at least one cut line in a third direction is between 0.1 mm and 1 mm, and the third direction is perpendicular to the first direction and the second direction.

12. The collection method of claim 9, wherein a length of the at least one cut line in the first direction is between 40% and 80% of a length of the main body in the first direction.

13. The collection method of claim 9, wherein a first distance is defined between the at least one cut line and an edge of the main body in the first direction, and the first distance is between 10% and 30% of a length of the main body in the first direction.

14. The collection method of claim 9, wherein the at least one cut line comprises at least two cut line segments and at least one interval between the at least two cut line segments.

15. A manufacturing method of an electronic device, applied with an electronic component collection, wherein the electronic component collection comprises:
a plurality of electronic components; and
at least one spacer, wherein the spacer is disposed between adjacent two of the electronic components, and the at least one spacer comprises:
a main body having a first surface and a second surface opposite to the first surface, wherein the first surface is adjacent to one of the adjacent two of the electronic components, and the second surface is adjacent to the other one of the adjacent two of the electronic components, and
at least one cut line formed on the main body and extending in a first direction parallel to the first surface, wherein the at least one cut line extends from the first surface to the second surface in a second direction so as to penetrate the main body;
the manufacturing method comprising:
retrieving the spacer from the electronic component collection;
retrieving one of the electronic components from the electronic component collection; and
forming the electronic device with the retrieved electronic component.

16. The manufacturing method of claim 15, wherein the electronic device comprises an LCD device or an LCD panel.

17. The manufacturing method of claim 15, wherein a width of the at least one cut line in a third direction is between 0.1 mm and 1 mm, and the third direction is perpendicular to the first direction and the second direction.

18. The manufacturing method of claim 15, wherein a length of the at least one cut line in the first direction is between 40% and 80% of a length of the main body.

19. The manufacturing method of claim 15, wherein a first distance is defined between the at least one cut line and an edge of the main body in the first direction, and the first distance is between 10% and 30% of a length of the main body in the first direction.

20. The manufacturing method of claim 15, wherein the at least one cut line comprises at least two cut line segments and at least one interval between the at least two cut line segments.
